(19) United States
(12) Patent Application Publication
(10) Pub. No.: US 2016/0300042 A1
(43) Pub. Date: Oct. 13, 2016

(54) LICENSING OF A HARDWARE COMPONENT

(71) Applicant: ABB Technology AG, Zürích (CH)

(72) Inventors: Beat Schaerz, Waldegg (CH); Luqman Munawar, Aalen (DE)

(21) Appl. No.: 15/183,516

(22) Filed: Jun. 15, 2016

Related U.S. Application Data
(63) Continuation of application No. PCT/EP2014/077389, filed on Dec. 11, 2014.

(30) Foreign Application Priority Data
Dec. 16, 2013 (EP) 13197504.7

(51) Int. Cl. G06F 21/10; G06F 9/445

(52) U.S. Cl. CPC G06F 21/105; G06F 9/44505

(57) ABSTRACT

The present invention provides a method for licensing of a hardware component connected to a real time data processing system, comprising, the steps of providing a software component enabling the use of the hardware component with the real time data processing system, which is executable on the real time data processing system, verifying a license for the hardware component in the software component, and activating the hardware component to make it usable to the real time data processing system upon successful verification of the license for the hardware component in the software component. The present invention also provides a real time data processing system connected to at least one HW component subject to licensing, whereby the real time data processing system is adapted to perform the above method.

### TECHNICAL FIELD

The present invention relates to a method for licensing of a hardware component connected to a real time data processing system and a real time data processing system adapted to perform the above method.

### BACKGROUND ART

Licensing in real time data processing system is becoming a more and more important issue. The real time data processing system can be any kind of control system, which can be used on any kind of customer needs for operation and control of a ship, a train, a power plant, or an offshore sub-station or components thereof, to name a few.

In this context, software (SW) functionality can easily be added by use of appropriate licenses. In respect to hardware (HW) components, configuration of the real time data processing system typically requires the HW modification of the real time data processing system, e.g. based on a large number of modular parts which are provided to a user according to the need. This configuration is static and requires adding/replacement of hardware parts on customer site every time the user wants a different HW configuration for his real time data processing system. The configuration of the real time data processing system includes scaling of the system, i.e. providing functionality with a different performance, in particular based on the use of different HW components, e.g. processing power, memory, or others. Examples for scaling of the real time data processing system and/or the HW components are CPU speed, priority of handling for specific tasks, memory, available I/O connections, FPGA features, built-in peripherals, and quality of service (QoS) parameters.

The configuration and scaling of the real time data processing system in terms of hardware therefore requires modification of the used HW components of the real time data processing system, either by adding, removing or replacing HW components. Nevertheless, the costs of HW components are nowadays determined by SW executed within the HW components to provide a desired functionality or other factors. Accordingly, physical modification of the real time data processing system may result in an effort, which is above the price of the pure hardware of the HW component. In particular, if the system is used in a location far away from the provider of the real time data processing system, already travel expenses for physical modification of the real time data processing system may exceed the price of the pure hardware, if e.g. a HW component shall be added to the real time data processing system.

From WO 2005/020514 A1 it is known to use a hardware system, which has a variable configuration. The configuration can be modified by use of a configuration control card. Nevertheless, also the configuration and scaling of the real time data processing system based on such a configuration control card requires physically providing the configuration control card to the real time data processing system. Accordingly, configuration and scaling of the real time data processing system is still very time-consuming and expensive.

Document US 2005/0060388 A1 relates to modifying hardware and program configuration of a computer. A computer configuration modification method comprises, upon reception of a configuration modification request for the hardware configuration and program configuration of the computer to be modified, transmitting the information regarding the hardware configuration to be modified to a hardware contract renewal notification destination in order to modify the fee to be paid for the modified hardware, and transmitting the information regarding the hardware configuration to be modified and the information regarding the program configuration to be modified to a program contract renewal notification destination in order to modify the fee to be paid for the modified program. When license information transmitted from the program contract renewal notification destination is inputted, the hardware configuration is modified based on the information regarding the hardware configuration to be modified and the program configuration is modified based on the information regarding the hardware configuration to be modified and the information regarding the program configuration to be modified.

Document U.S. Pat. No. 6,810,438 B1 refers to a method for enabling value-added hardware on an interfaceboard in a computer system. The method first determines whether an interface board is connected to a bus of a computer system. Then, a general-purpose top-level device driver, which controls standard functions associated with the interface board, is loaded into kernel memory space of the computer system. Next, a value-added device driver is loaded into memory of the computer system. The valueadded device driver corresponds to the interface board determined to be connected to the bus of the computer system. Predetermined information, such as a password, or confidential or cryptographic information, is stored at a predetermined address within a memory space of the interface board. The predetermined address corresponds to a predetermined address within value-added hardware on the interface board. A predetermined response is received from the interface board based on the predetermined information. Access to the value-added hardware is enabled through the value-added device driver when the predetermined response is an expected response. The value-added device driver can be loaded into kernel memory of the computer, or can be part of an application program that is loaded into user memory of the computer.

### DISCLOSURE OF INVENTION

It is an object of the present invention to provide a method for licensing of a hardware component connected to a real time data processing system and a real time data processing system adapted to perform the method, which enable efficient configuration and scaling of the real time data processing system.

This object is achieved by the independent claims. Advantageous embodiments are given in the dependent claims.

In particular, the present invention provides a method for licensing of a hardware component connected to a real time data processing system, comprising the steps of providing a software component enabling the use of the hardware component with the real time data processing system, which is executable on the real time data processing system, verifying a license for the hardware component in the software component comprising accessing a license storage, and verifying available licenses from the license storage, and activating the hardware component to make it usable to the real time data processing system upon successful verification of the license for the hardware component in the software component.

The present invention also provides a real time data processing system connected to at least one HW component subject to licensing, whereby the real time data processing system is adapted to perform the above method.

The basic idea of the invention is to enable hardware (HW) licensing by means of software (SW) licensing. The SW component can be any kind of SW that enables the use of the HW component. The SW component may be part of an operating system of the real time data processing system or any kind of additional SW, which can be added independently to the real time data processing system. Preferably, the SW component is a kind of driver for connecting the HW component to the real time data processing system. The activation of the HW component is a step that enables the use of the HW component with the real time data processing system. Accordingly, the activation may be performing a setting in the SW component, which enables the use of the HW component. The activation comprises maintaining the HW component in an active state, so that it is kept usable to the real time data processing system, e.g. in the case of a default activation of the HW component or repeated verification of the license, when the HW component has already been activated due to a prior successful license verification. Accordingly, If the verification of the license fails, an explicit de-activation may be performed in the above cases. The connection of the HW component to the real time data processing system can be any kind of permanent or temporary connection, i.e. the HW component can be a built-in component like a CPU, or any kind of extension to the real time data processing system, which may be a removable or built-in extension. Nevertheless, the HW component does not require to be included or to be directly attached to the real time data processing system with the SW component. The respective HW component can be connected via a remote link, e.g. using a network connection like a TCP/IP connection Preferably, the license verification is done each time the HW component is used. In general, the SW component is provided for an individual HW component. Nevertheless, also one SW component may be provided to verify the license of multiple HW components. Still further, the SW component is not necessarily a single item executed on the real time data processing system, it may comprise multiple individual components, which together provide the described functionality. The license enables the usage of the identical HW components according to the coverage of the license, so that different functionalities can be realized by the HW component. Accordingly, the HW components may be easily scaled to provide different functionalities depending on the license, but not on the HW component itself. The license can be a license for a unique HW component or for a HW component, which is chosen from a group of HW components, e.g. from a group of identical HW components.

The license storage contains preferably licenses for multiple HW components. The license storage may also be a kind of central license storage for storing the licenses of HW components for multiple real time data processing systems. The license storage may be part of the real time data processing system, i.e. the licenses are stored on the real time data processing system, or in a remote storage, which may be connected to the real time data processing system via any kind of communication link, e.g. via a network connection, preferably via a TCP/IP network connection. Alternatively, the license may be stored on the HW component. The license storage may be used also to store further information in respect to the license, e.g. a fleet identification as discussed below. The license storage is preferably tamper proof. Verification of the license from the license storage preferably comprises verification if a license for a HW component is present. The license storage is preferably accessible from a data processing device to update licenses therein, i.e. to add, delete or modify licenses.

According to a modified embodiment of the invention the step of activating the hardware component to make it usable to the real time data processing system upon successful verification of the license for the hardware component in the software component comprises invalidating the license after a predefined number of activations of the hardware component and/or after a predefined activation time of the hardware component. This enables the use of licenses, which may expire upon usage. The number of activations and/or the predefined activation time of the hardware component are preferably specified by the license.

According to a modified embodiment of the invention the step of verifying available licenses from the license storage comprises using encryption and/or authentication. The usage of encryption and/or authentication can refer to the license itself, which can be encrypted and have an access protection based on authentication. The usage of encryption and/or authentication can also refer to a communication between the license storage and the SW component. The usage of encryption and/or authentication provides a means of protection against tampering and misuse.

According to a modified embodiment of the invention the method comprises using encryption when communicating with the hardware component. This refers in particular to activation and/or de-activation of the HW component, so that the license verification cannot be avoided, in particular the license verification cannot be avoided intentionally.

According to a modified embodiment of the invention the steps of verifying a license for the hardware component in the software component and activating the hardware component to make it usable to the real time data processing system upon successful verification of the license for the hardware component in the software component is executed after detection of a license verification trigger event. The trigger event may be any kind of event that may be generated by the HW component, the real time data processing system or even from outside the real time data processing system. E.g. license verification may be performed, when the real time data processing system access the HW component, i.e. the HW component is used. Additionally or alternatively, the trigger event may be generated after expiry of a timer, e.g. a license verification timer. Still further, the trigger event may be generated upon events independent from the HW component itself, e.g. when the real time data processing system performs any kind of operation. Still further, the trigger event may be generated externally, e.g. from a network device connected to the real time data processing system via a network connection and/or an internet connection. Accordingly, a general verification of licenses may be triggered, e.g. by the provider of the HW component and/or the real time data processing system and/or the license. With the verification of the license based on the trigger event, the license can be verified repeatedly to avoid misuse. This is particularly important in a real time data processing system, where in principle a HW component may be activated once and will be continuously used. In that case, expiry of the license would not be recognized when the license is only verified upon start-up of the HW component or the real time data processing system, since usage of the HW component will not stop. In case the license is not available anymore or not valid anymore, the HW component linked to that license can be de-activated.

According to a modified embodiment of the invention the method comprises the additional step of adding at least one hardware component to the real time data processing system, and the step of providing a software component enabling the use of the hardware component with the real time data processing system comprises providing a SW component enabling the use of the added hardware component with the real time data processing system. This enables modification of the real time data processing system in respect to HW components on the fly, e.g. during operation. The HW components can be added and/or removed from the real time data processing system without impacting the behavior of the real time data processing system itself. The SW component may be permanently active, activated prior to adding the HW component, or may be activated after adding the HW component. When the HW component is linked to the SW component, it may be activated at any time depending on the license verification. Each HW component can be connected to an individual SW component, so that the SW component has to be started prior to license verification of the HW component, either prior to or after adding the HW component. Alternatively, one SW component may be used for multiple HW components. Hence, when the HW component is added, the SW component is probably already activated on the real time data processing device, so that no further activation of SW components is required.

According to a modified embodiment of the invention the method comprises the additional step of monitoring the connection of at least one hardware component to the real time data processing system, wherein the method of any of the previous claims is performed upon detection of the connection of the at least one hardware component. Hence, the real time data processing system may detect automatically the added HW component, and the HW component may be automatically activated after successful license verification. Accordingly, the real time data processing system may activate its HW components. Preferably, disconnection or removal of a HW component is also monitored. Still further preferred, the real time data processing system comprises a license validation controller for monitoring HW modifications, e.g. the addition and/or removal of a HW component. Still further preferred, the license validation controller also executes the SW component and performs the license verification.

According to a modified embodiment of the invention the step of verifying a license for the hardware component in the software component comprises receiving a device identification from the hardware component and verifying the device identification, and the step of activating the hardware component upon successful verification of the license for the hardware component in the software component comprises activating the hardware component upon successful verification of the device identification of the hardware component. This enables bundling a license to a particular hardware, so that an uncontrolled transfer of HW components between different real time data processing systems can be avoided. Also the uncontrolled exchange of licenses between real time data processing systems can be avoided. The device identification can be a unique identification, which can e.g. be calculated by examining some HW specifications of the HW components. For example, a hash sum can be calculated based on serial numbers of HW items of the HW components.

According to a modified embodiment of the invention the method comprises the additional step of assigning the device identification to the hardware component. Accordingly, the device identification can be set depending on particular needs. Preferably, the device identification is provided to identify groups of HW components, e.g. based on customer identifications, the real time data processing device, for which the HW components is to be used, or any other requirement to avoid uncontrolled use of HW components which might cause problems in the real time data processing device. The device identification can be assigned to the HW component prior to usage in the real time data processing system, e.g. as a production step of the HW component. Alternatively, the device identification can be assigned to the HW component when connected to the real time data processing system, e.g. during run-time. Preferably, the device identification is provided in a tamper proof storage to avoid uncontrolled usage or misusage of the HW component.

According to a modified embodiment of the invention the step of assigning the device identification to the hardware component comprises assigning the device identification to the hardware component depending on a hardware component group. The hardware component group may be a logical identifier, e.g. depending on the real time data processing system, a class of real time data processing systems, a customer, or others. The hardware component group enables easy replacement of HW components having the same hardware component group. Accordingly, the device identification may be a fleet identification for identifying HW components, which may be exchanged with each other under use of the same license. Also functionality of the real time data processing system may be easily extended by adding the fleet-specific HW components.

According to a modified embodiment of the invention the step of assigning the device identification to the hardware component depending on a hardware component group comprises assigning the device identification to the hardware component depending on a hierarchy level within the hardware component group. This allows creating sub-groups of fleets of HW components with partly compatible functionality. HW components from a base group include functionality from this base group only. Thus a HW component from the base group can act as a replacement for a HW component of the same sub-group. Further, different base groups, which are arranged on the same hierarchy level, can be defined. A superior group of HW components can be defined, e.g. to replace HW components of subordinate groups, e.g. the base groups. Nevertheless, HW components from the base group cannot substitute HW components of the superior group. The definition of base groups and superior groups adds safety features to the configuration of the real time data processing system and avoids damage resulting from misconfiguration.

According to a modified embodiment of the invention the step of providing a software component enabling the use of the hardware component with the real time data processing system, which is executable on the real time data processing system, comprises providing a licensing hardware component for executing the software component. The licensing HW component may be any kind of HW component of the real time data processing system. Alternatively, the licensing hardware component is a removable HW component of the real time data processing system. The licensing hardware component monitors the connection/removal of HW components, so that the SW component for the respective HW component can be provided and a license verification for the HW component can be performed.

According to a modified embodiment of the invention the real time data processing system is connected to multiple hardware components, wherein the step of providing a software component for the hardware component comprises providing one software component for the multiple hardware components, and the step of verifying a license for the hardware component in the software component comprises verifying the license for multiple hardware components in the software component. The use of a single SW component for multiple HW components may facilitate the implementation of the SW component in the real time data processing system. Nevertheless, also multiple SW components can be provided, each of which for verification of multiple HW components.

According to a modified embodiment of the invention the real time data processing system comprises a licensing hardware component, whereby the SW component is executed on the licensing hardware component. In accordance with the above described feature, the licensing hardware component can be provided for execution of the SW component, for monitoring the connection of at least one hardware component to the real time data processing system and/or as license validation controller.

### BRIEF DESCRIPTION OF DRAWINGS

These and other aspects of the invention will be apparent from and elucidated with reference to the embodiments described hereinafter.

In the drawings:

FIG. 1 shows a real time data processing system according to a first embodiment of the invention comprising four hardware components,

FIG. 2 shows a real time data processing system according to second embodiment of the invention comprising one remotely connected hardware component,

FIG. 3 shows two real time data processing systems according to a third embodiment with each real time data processing system comprising three hardware components with different device identifications,

FIG. 4 shows a real time data processing system according to a fourth embodiment of the invention comprising three hardware components on two hierarchy levels, and

FIG. 5 shows a diagram for visualizing a method for licensing of a hardware component connected to a real time data processing system in accordance with the above embodiments.

### DETAILED DESCRIPTION OF THE INVENTION

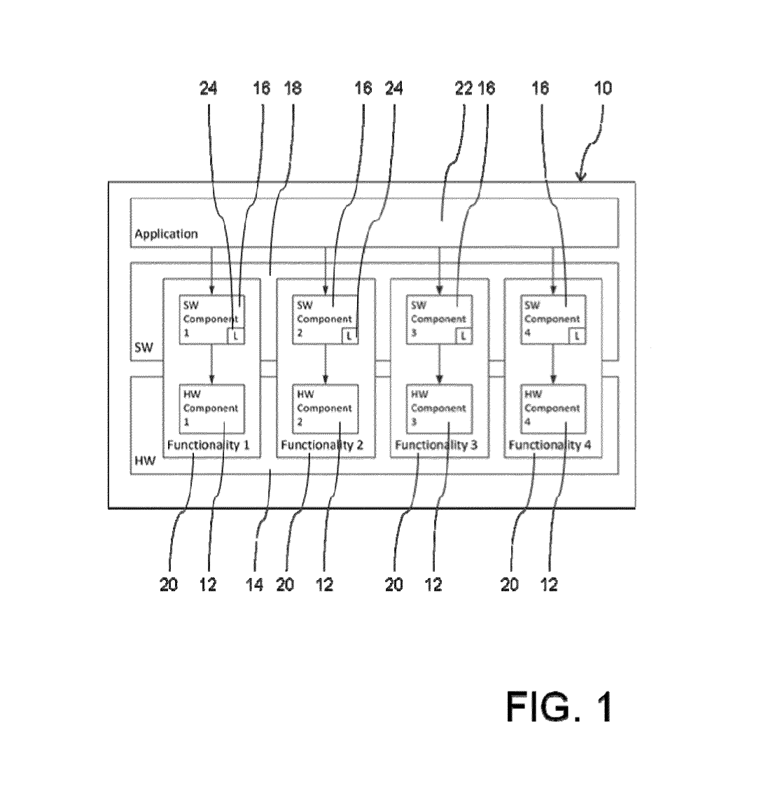

FIG. 1 schematically illustrates a real time data processing system 10 according to a first embodiment of the invention. The real time data processing system 10 comprising four hardware (HW) components 12, which define a hardware level 14, and which are subject to licensing. The HW components 12 in this embodiment are directly connected to the real time data processing system 10.

In this embodiment, four individual software (SW) components 16 are provided on a software level 18. Each SW component 16 is connected to one HW component 12 to enable the use of the HW component 12 in the real time data processing system 10. Accordingly, each pair of HW component 12 and SW component 16 provides a functionality 20 to the real time data processing system 10, and which can be accessed in this embodiment by an application 22 executed on the real time data processing system 10. The SW component 16 in this embodiment is a driver for connecting the HW component 12 to the real time data processing system 10, which is executable on the real time data processing system 10.

As can be further seen in FIG. 1, each SW component 16 verifies license 24 for activation of the respective HW component 12. The SW component 16 in this embodiment verifies the license 24 for the HW component 12 and activates the HW component 12 to make it usable to the real time data processing system 10 upon successful verification of the license 24.

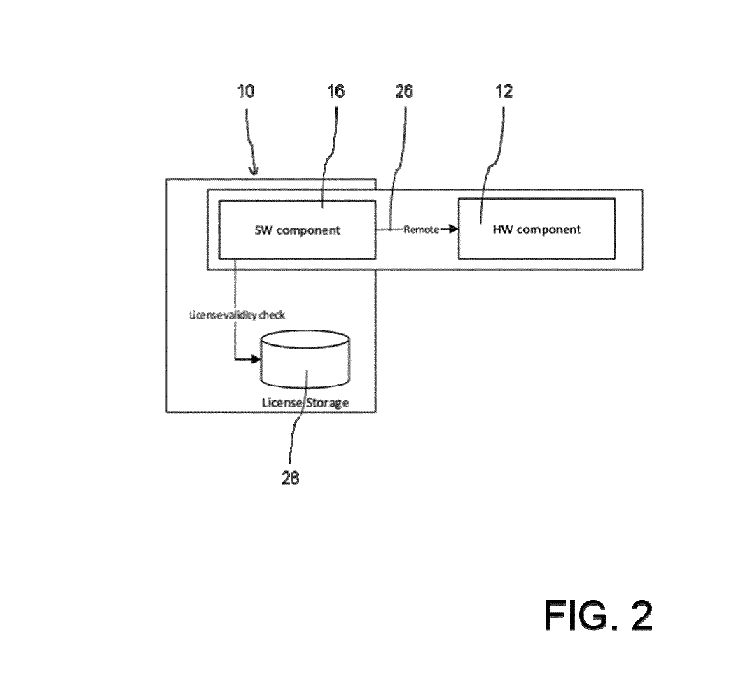

FIG. 2 schematically illustrates a real time data processing system 10 according to a second embodiment of the invention. The real time data processing system 10 is provided in accordance with the above real time data processing system 10 according to the first embodiment.

In difference to the real time data processing system 10 of the first embodiment, the real time data processing system 10 of the second embodiment comprises a single HW component 12, which is connected via a network connection 26 like a TCP/IP connection to the real time data processing system 10. Accordingly, the HW component 12 can be easily removed from the real time data processing system 10. The SW component 16 is executed on the real time data processing system 10 as described in respect to the first embodiment.

As can be seen in FIG. 2, a license storage 28 is part of the real time data processing system 10. The license storage 28 stores the license 24 using encryption. Furthermore, access protection based on authentication is enabled for the license storage 28. The license storage 28 is tamper proof.

When the SW component 16 verifies the license 24 of the hardware component 12, available licenses 24 from the license storage 28 are verified and the HW component 12 is activated, if a valid license 24 for the HW component 12 is present in the license storage 28. The license storage 28 in this embodiment is a central license storage 28 for storing the licenses 24 of different HW components 12 connectable or connected to the real time data processing system 10. The license storage 28 is accessible from a remote data processing device, which is not shown in the figure, to update licenses 24 therein.

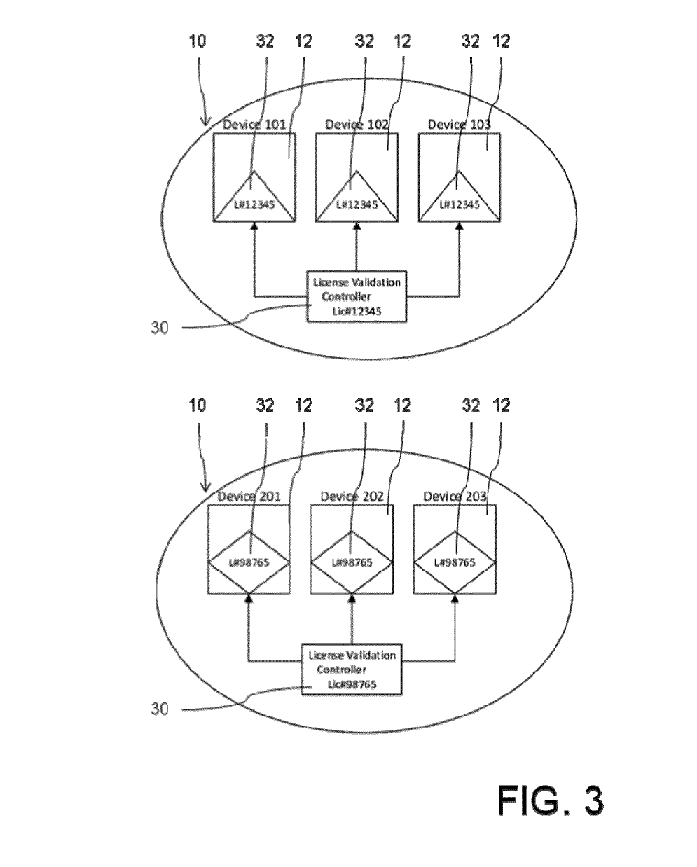

FIG. 3 schematically shows two implementations of a real time data processing system 10 according to a third embodiment of the invention. Each real time data processing system 10 is provided in accordance with the above real time data processing systems 10 according to the first and second embodiment.

Each real time data processing system 10 comprises three HW components 12, which are directly connected to the respective real time data processing system 10. In particular, the real time data processing system 10 comprises a license verification controller 30, which is connected to the HW components 12. In this embodiment, the SW components 16 are executed on the license verification controller 30. Accordingly, the license verification controller 30 is used as licensing hardware component.

As can be further seen in FIG. 3, each HW components 12 comprises a device identification 32, which is unique for each group of HW components 12 of one the real time data processing systems 10, but distinct when comparing the device identifications 32 of the two groups HW components 12 of the two real time data processing systems 10. Accordingly, when the license verification controller verifies the license 24, also the device identifications 32 is verified, which results in a rejection of HW components 12 having a different device identifications 32, i.e. HW components 12 from the two real time data processing systems 10 cannot be exchanged among the real time data processing systems 10.

The device identification 32 is assigned to the hardware components 12 in a tamper proof storage thereof. The device identification 32 is assigned as a production step of the HW component 12 prior to usage in the real time data processing system 10. The device identification 32 in this embodiment is a fleet identification for identifying HW components 12, which may be exchanged with each other under use of the same license 24 in one real time data processing system 10.

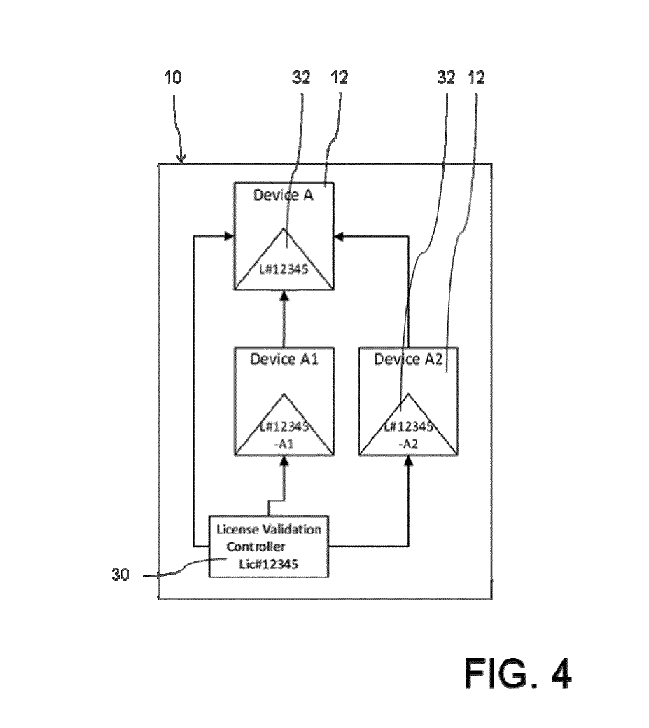

FIG. 4 schematically illustrates a real time data processing system 10 according to a fourth embodiment of the invention. The real time data processing system 10 is provided in accordance with the above real time data processing system 10 according to the first, second and third embodiment.

According to the fourth embodiment, the device identification 32 is assigned to the HW components 12 depending on a hardware component group depending on a hierarchy level within the hardware component group. Accordingly, as can be seen in FIG. 4, based on the group of HW components 12 of the real time data processing system 10 of the fourth embodiment, the HW components 12 are grouped in two hierarchy levels, with two groups, identified with the extension -A1 and -A2 in the device identification 32 respectively, on a base hierarchy level, also referred to as base groups, and one group on a superior hierarchy level, also referred to as superior group, which has no extension in the device identification 32. HW components 12 of the superior group can be enabled to replace HW components 12 of the base groups.

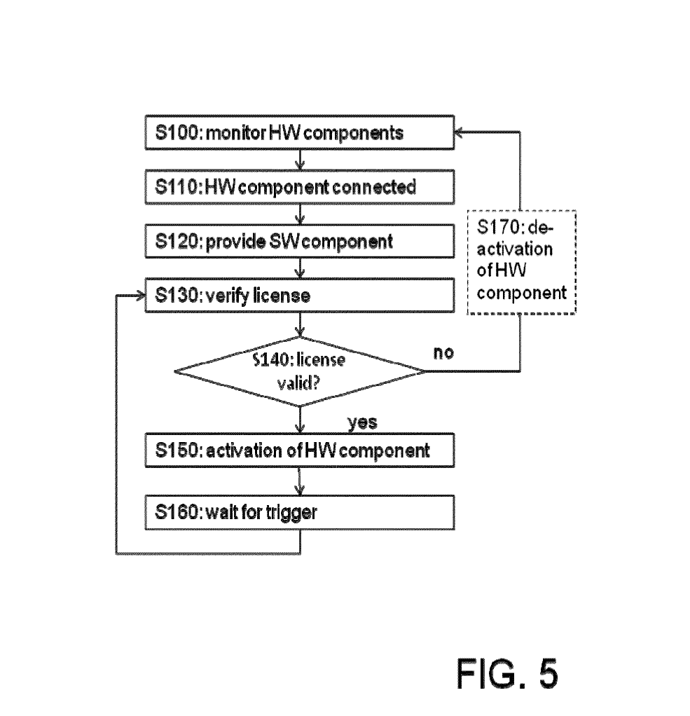

With reference to FIG. 5 is now described a method for licensing of a HW component 12, which is connected to a real time data processing system 10 as described above in respect to the above embodiments. The method can in general be performed with any of the four embodiments described above. If reference is made to details which are not available to all embodiments, the respective method steps are only applicable to the embodiments supporting the details.

The method starts with step S100. This initiates monitoring the connection of a HW component 12 to the real time data processing system 10. The license validation controller 30 monitors, if a new HW component is added. If not license validation controller 30 is present, the real time data processing system 10 monitors, if a new HW components 12 has been added.

In step S110, a HW component 12 is added to the real time data processing system 10. Accordingly the method continues with step S120.

In step S120, the SW component 16 is provided on the real time data processing system 10, i.e. execution of the SW component 16 is started. The SW component 16 is provided on the license validation controller 30. If not license validation controller 30 is present, the SW component 16 is provided on the real time data processing system 10.

In step S130, verification of the license 24 for the HW component 12 is started by the SW component 16. In case the license storage 28 is available, the SW component 16 accesses the license storage 28 and verifies available licenses 24 from the license storage 28. If no license storage 28 is available, the available license 24 for the added HW component 12 is provided to the SW component 16 for verification purpose. Furthermore, if the HW component 12 has a device identification 32, the device identification 32 is transmitted from the HW component 12 to the SW component. Then, the device identification 32 and the license 24 are verified for the added HW component 12.

In step S140 the result of the verification step S130 is evaluated. If the license 24 and the device identification 32, if applicable, are valid, the method continues with step S150, otherwise the method returns to step S100 and monitors again, if a HW component 12 is added to the real time data processing system 10.

In step S 150 the HW component 12 is activated upon successful verification of the license 24 and the device identification 32, if applicable. Accordingly, the HW component 12 is enabled for use in the real time data processing system 10 by the application 22.

In step S 160, the method waits for a license verification trigger event. IN this embodiment, the license verification trigger event is generated upon expiry of a license verification timer of the real time data processing system 10. The timer is set to a given time to repeatedly verify the license 24 of the HW component 12. Upon detection of the license verification trigger event, the method returns to step S130 to verify the license 24 of the HW component 12.

In case the verification of the license 24 fails after a prior activation of the HW component, an additional step S170 is added to de-activate the HW component 12.

While the invention has been illustrated and described in detail in the drawings and foregoing description, such illustration and description are to be considered illustrative or exemplary and not restrictive; the invention is not limited to the disclosed embodiments. Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting scope.

### REFERENCE SIGNS LIST

10 real time data processing system
12 hardware component
14 hardware level
16 software component
18 software level
20 functionality
22 application
24 license
26 network connection
28 license storage
30 license verification controller, licensing hardware component
32 device identification

1. Method for licensing of a hardware component connected to a real time data processing system, comprising the steps of
providing a software component enabling the use of the hardware component with the real time data processing system, which is executable on the real time data processing system,
verifying a license for the hardware component in the software component comprising accessing a license storage and verifying available licenses from the license storage, and
activating the hardware component to make it usable to the real time data processing system upon successful verification of the license for the hardware component in the software component.

2. Method for licensing of a hardware component connected to a real time data processing system according to preceding claim 1, wherein
the step of activating the hardware component to make it usable to the real time data processing system upon successful verification of the license for the hardware component in the software component comprises invalidating the license after a predefined number of activations of the hardware component and/or after a predefined activation time of the hardware component.

3. Method for licensing of a hardware component connected to a real time data processing system according to claim 1, wherein
the step of verifying available licenses from the license storage using encryption and/or authentication.

4. Method for licensing of a hardware component connected to a real time data processing system according to claim 1, wherein
the steps of verifying a license for the hardware component in the software component and activating the hardware component to make it usable to the real time data processing system upon successful verification of the license for the hardware component in the software component is executed after detection of a license verification trigger event.

5. Method for licensing of a hardware component connected to a real time data processing system according to claim 1, comprising the additional step of
adding at least one hardware component to the real time data processing system, and
the step of providing a software component enabling the use of the hardware component with the real time data processing system comprises providing a SW component enabling the use of the added hardware component with the real time data processing system.

6. Method for licensing of a hardware component connected to a real time data processing system according to preceding claim 5, comprising the additional step of
monitoring the connection of at least one hardware component to the real time data processing system, wherein
the method is performed upon detection of the connection of the at least one hardware component.

7. Method for licensing of a hardware component connected to a real time data processing system according to claim 1, wherein
the step of verifying a license for the hardware component in the software component comprises receiving a device identification from the hardware component and verifying the device identification, and
the step of activating the hardware component upon successful verification of the license for the hardware component in the software component comprises activating the hardware component upon successful verification of the device identification of the hardware component.

8. Method for licensing of a hardware component connected to a real time data processing system according to claim 7, comprising the step of assigning the device identification to the hardware component.

9. Method for licensing of a hardware component connected to a real time data processing system according to claim 8, wherein
the step of assigning the device identification to the hardware component comprises assigning the device identification to the hardware component depending on a hardware component group.

10. Method for licensing of a hardware component connected to a real time data processing system according to claim 9, wherein
the step of assigning the device identification to the hardware component depending on a hardware component group comprises assigning the device identification to the hardware component depending on a hierarchy level within the hardware group.

11. Method for licensing of a hardware component connected to a real time data processing system according to claim 1, wherein
the step of providing a software component enabling the use of the hardware component with the real time data processing system, which is executable on the real time data processing system, comprises providing a licensing hardware component for executing the software component.

12. Method for licensing of a hardware component connected to a real time data processing system according to claim 1, wherein the real time data processing system is connected to multiple hardware components, wherein
the step of providing a software component for the hardware component comprises providing one software component for the multiple hardware components, and
the step of verifying a license for the hardware component in the software component comprises verifying the license for multiple hardware components in the software component.

13. Real time data processing system connected to at least one HW component subject to licensing, whereby the real time data processing system is adapted to perform the method according to claim 1.

14. Real time data processing system according to preceding claim 13, comprising a licensing hardware component, whereby SW component is executed on the licensing hardware component.

15. Method for licensing of a hardware component connected to a real time data processing system according to claim 2, wherein the step of verifying available licenses from the license storage using encryption and/or authentication.

16. Method for licensing of a hardware component connected to a real time data processing system according to claim 2, wherein the steps of verifying, a license for the hardware component in the software component and activating the hardware component to make it usable to the real time data processing system upon successful verification of the license for the hardware component in the software component is executed after detection of a license verification trigger event.

17. Method for licensing of a hardware component connected to a real time data processing system according to claim 1, wherein:
the step of activating the hardware component to make it usable to the real time data processing system upon successful verification of the license for the hardware component in the software component comprises invalidating the license after a predefined number of activations of the hardware component or after a predefined activation time of the hardware component;
wherein the step of verifying available licenses from the license storage using one of encryption or authentication;
wherein the steps of verifying a license for the hardware component in the software component and activating the hardware component to make it usable to the real time data processing system upon successful verification of the license for the hardware component in the software component is executed after detection of a license verification trigger event.

18. Method for licensing of a hardware component connected to a real time data processing system according to claim 2, comprising the additional step of adding at least one hardware component to the real time data processing system, and the step of providing a software component enabling the use of the hardware component with the real time data processing system comprises providing, a SW component enabling the use of the added hardware component with the real time data processing system.

19. Method for licensing of a hardware component connected to a real time data processing system according to claim 2, wherein:
the step of verifying a license for the hardware component in the software component comprises receiving a device identification from the hardware component and verifying the device identification; and
the step of activating the hardware component upon successful verification of the license for the hardware component in the software component comprises activating the hardware component upon successful verification of the device identification of the hardware component.

20. Method for licensing of a hardware component connected to a real time data processing system according to claim 3, wherein:
the step of verifying a license for the hardware component in the software component comprises receiving a device identification from the hardware component and verifying the device identification; and
the step of activating the hardware component upon successful verification of the license for the hardware component in the software component comprises activating the hardware component upon successful verification of the device identification of the hardware component.
